(19) United States
(12) Patent Application Publication
(10) Pub. No.: US 2014/0173830 A1
(43) Pub. Date: Jun. 26, 2014

(54) Truck Power Puller Device for Semi-tractor and Trailer Applications

(71) Applicant: Robert Arthur, Anderson, IN (US)

(72) Inventor: Robert Arthur, Anderson, IN (US)

(21) Appl. No.: 14/094,263

(22) Filed: Dec. 2, 2013

Related U.S. Application Data
(60) Provisional application No. 61/732,535, filed on Dec. 3, 2012.

(51) Int. Cl. B25F 1/00

(52) U.S. Cl. CPC B25F 1/006
USPC 7/146

(57) ABSTRACT

A multipurpose truck power puller device for semi-tractor and trailer applications used by truck operators to release a fifth wheel pin of a tractor/trailer assembly, adjust tandem axle trailer pins, adjust load bars, and use as a general purpose mallet, the device being comprised of a heavy massed mallet handle section, a bend-resisting shaft, a loop section and a hook, all the parts integrally manufactured and having a means to connect the components as a single durable assembly wherein the puller device can be used as a portable apparatus adapted for a one-person application, and which is further adapted for operating a fifth wheel pin; a tandem wheel adjustment system for a tractor trailer; a safety reach mechanism for load bars; and a general purpose mallet.

### CROSS-REFERENCE TO RELATED APPLICATIONS

This application claims the benefit of Provisional Patent Application Ser. No. 61/732,535 filed Dec. 3, 20120 by Robert Arthur and entitled “A Special Truck Power Puller device for Semi-tractor and trailer applications”.

### FIELD OF INVENTION

This invention relates to a multipurpose truck power puller device for semi-tractor and trailer applications known as Extreme Release™. Particularly this invention relates to tools employed by truck operators and, more particularly, to such tools used to release a fifth wheel pin of a tractor/trailer assembly or the wheel adjustments and tandem axle trailer pin extractor apparatus. This invention is a decoupling tool for unlocking a fifth wheel assembly to allow decoupling of a trailer from a tractor and also a tool for shifting the locking pins in the undercarriage of a tandem axle trailer when it is desired to shift the position of the trailer body relative to the tandem axles.

### FEDERALLY SPONSORED RESEARCH

None.

### SEQUENCE LISTING OR PROGRAM

None.

### BACKGROUND-FIELD OF INVENTION AND PRIOR ART

### Introduction

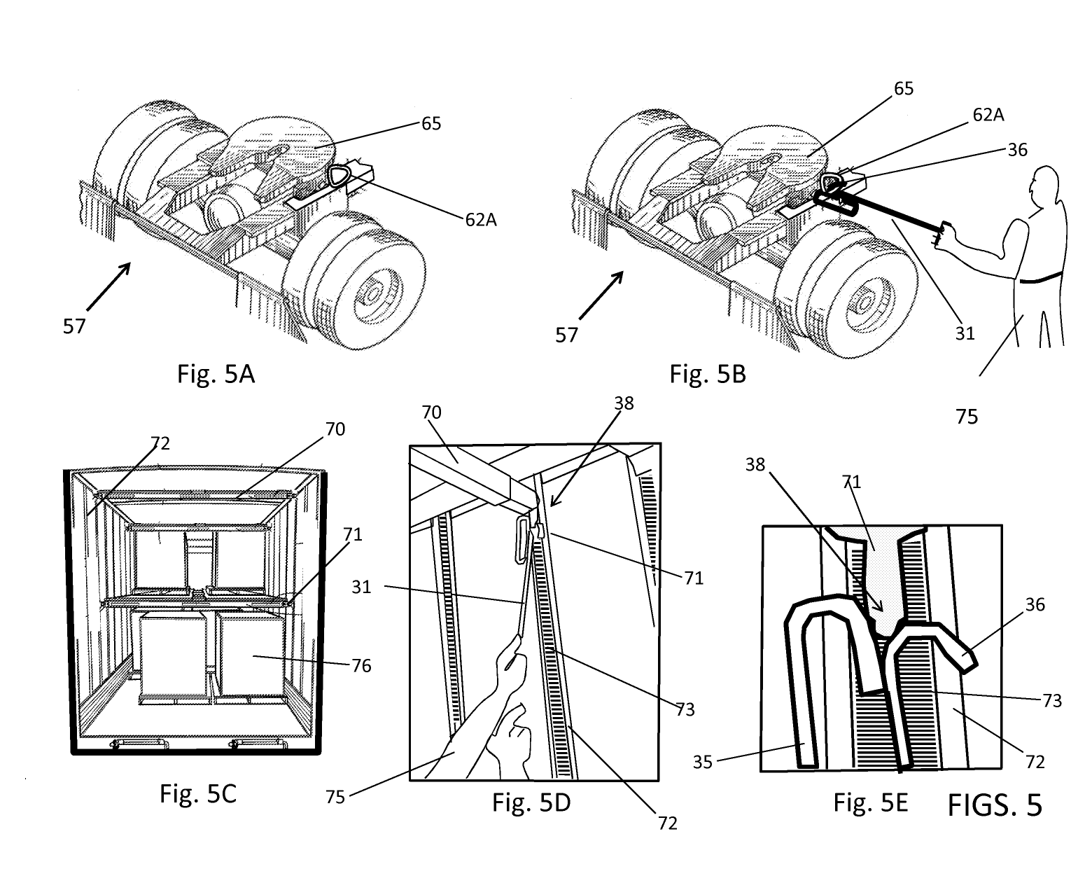

In a normal semi-tractor and trailer driving and employment case, a truck operator's primary responsibility is to drive the tractor/trailer, while a truck mechanic performs repair and maintenance on such tractor/trailers. However, the truck operator is often responsible and called upon to perform duties such as disconnecting the tractor from the trailer and repositioning the wheels on the trailer. Unlike a mechanic, truck operators traditionally do not have a full complement of tools available for performing their duties. For example, the truck operator is often called on to disconnect or uncouple a fifth wheel pin employed to connect the trailer to the tractor. See FIG. 5 in the reference drawings. The fifth wheel pin is located between the tractor and the trailer above the rear tires of the tractor. The truck operator/driver is expected to bend down/over and reach between the tractor and the trailer past one set of rear tires to pull the fifth wheel pin. This action requires the operators to contort themselves into an awkward position while pulling the pin and often results in the operators straining any number of body parts, such as shoulders, elbows, and wrists and especially their backs. On many occasions, an injury manifests itself and a workers comprehensive insurance claim results.

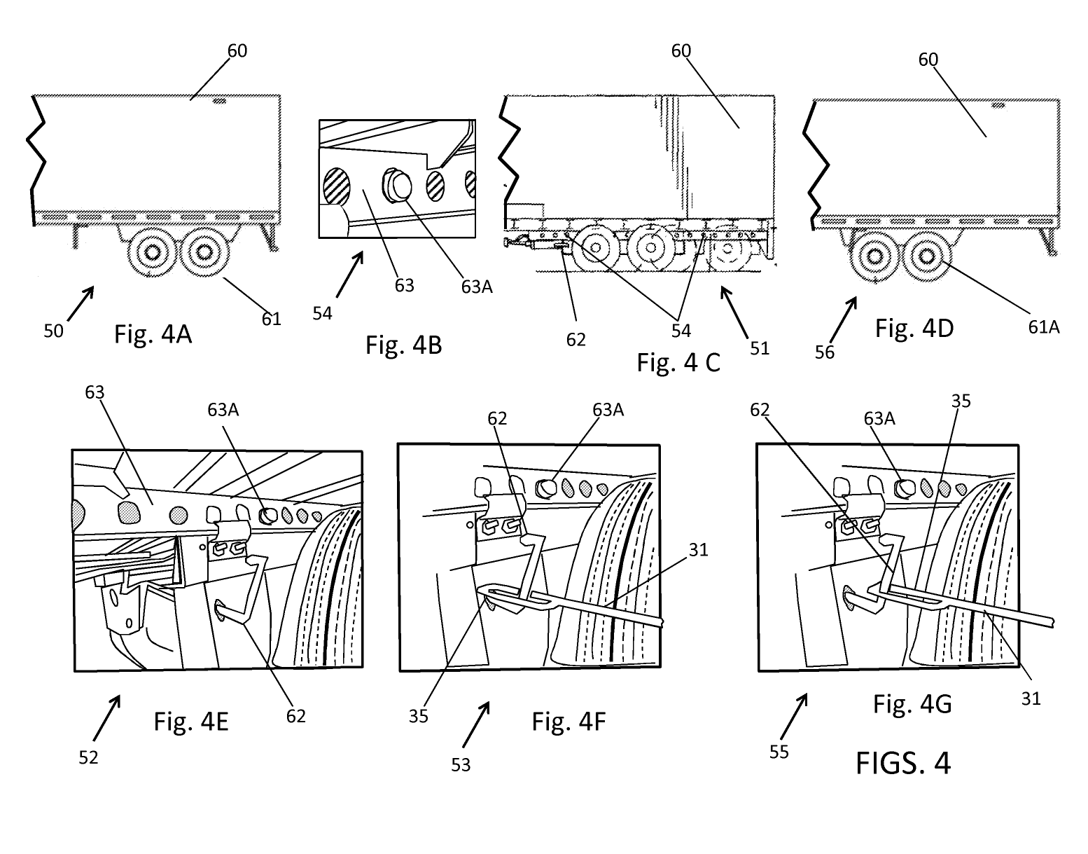

In addition to the fifth-wheel, many/most semi-trailers are equipped with longitudinally-adjustable, tandem axle frame assemblies which adjust and slide the rear set of wheels to the front or back in order to better distribute a load over the wheels or to help support the rear of the trailer during loading. See FIG. 4 in the reference drawings. Generally, the tandem axle frame assemblies are secured to a sub-frame of the trailer by a series of heavy spring-loaded pins. The pins are spring-urged in such a manner whereby pins attempt to seat themselves within a series of holes in a locking position in the sub-frame and tandem axle frame. In this case, a tandem lock pin release handle which extends outward of the frame is provided in order to facilitate extraction or withdrawal of the spring loaded pins from the holes in order to make the tandem axle frame adjustment. When the release handle is pulled on the tandem mechanism, a relatively strong pulling force is exerted, thereby facilitating extraction of the pins so as to allow the tandem axle subframe to be repositioned and to allow the pins to seek appropriate holes to establish and lock into a new position of the trailer relative to the tandem axles. However, often times the immensity of the masses involved with the trailer and the tandem axles and the forces there between causes the pins to be lodged and stuck in the apertures and thus in the locking position. Because the operator is incapable of applying sufficient force to extract the jammed pins, he or she is required to return to his cab and slightly rock the semi-truck trailer back and forth in an attempt to dislodge the pins. The operator then re-attempts to pull the release handle in order to facilitate pin withdrawal. Alternatively, operator is required to seek the help of an assistant who can pull the release handle while operator slightly rocks semi-truck trailer back and forth.

As a further “tandem” description, most if not all truck semi-trailers are equipped with this sliding tandem frame which is slid to adjust wheels and thus the weight distribution of the cargo inside the semi-trailer. On the frame, where the tandem wheels slide back and forth, there are normally four pins inside. These pins fit through openings in the flange-like frame on the side of the trailer box and extend to openings in the tandem frame. The release handle is positioned underneath the pins and extending toward the outside of the trailer. The release handle is connected to the linkage which, when pulled, simultaneously extracts all four pins whereby the carriage can be repositioned and the pins allowed to seek appropriate bores to securely establish the new location of the trailer body relative to the tandem axles. The pins come in when the handle is pulled and the trailer frame then may slide on the tandem frame. In order for the tandem frame to slide, the holes must be lined up and the pins pulled out. As mentioned above, if the pins are not properly lined up into the holes of the frame, the pins will stick and be very difficult to pull out. Then the semitrailer must be rocked back and forth until the pins line up. Usually the pins are pulled manually and often two people are needed to do the job. There are some trucks outfitted with a device for pulling pins called a mule, which is air-operated and permanently affixed. These have received mixed acceptance in the field of trucking.

Another area where drivers need assistance is with load bars. See FIG. 5 in the reference drawings. These load bars are used inside the trailers to separate loads for different clients and/or stops. Likewise, they are used to secure the boxes, pallets and other cargo from shifting. A common load bar is a telescoping, essentially horizontal bar or tube structure that engages vertical side rails. These side rails have a retention mechanism that engages a ratchet system in the middle of the vertical side rails. The operator/driver has to often climb on unsteady boxes to reach a higher load bar. If the horizon top load bar engages the side rails, the bar falls and gravity lets the bar drop—and many times the falling bar hits the operator below. A device to reach and engage the load bar and retention mechanism would make this activity much safer and ergonomically correct.

### Problem Stated

One may note that light tools having a thin shaft and a hook on the end thereof have been used in the past to pull fifth wheel pins, but these tools are awkward to use and store, light weight, and are used only for a single purpose: removing fifth wheel pins. Also, these light and open-hook devices may slip off the handle and precipitate falls by the driver. Accordingly, a first need has arisen for a portable apparatus adapted for one-person application, and which is further adapted for being removably securable to a tractor trailer in order to extract adjust fifth wheels or pull the tandem lock pin release handle in a manner which is quick, easy, and efficient.

Further and commonly, the wheel lock release lever is located on the lower portion of the hitch assembly under the front end of the semi-trailer. Typically the operator must stretch to reach the lock release lever. A strong jerking motion is preferred however it is difficult to jerk the lock release lever because of its position.

The difficulty with the afore described tandem arrangement lies with the fact that the magnitude of the masses involved with the trailer body and the tandem axles and the forces there between tends to cause the pins to be jammed in the locking position. Thus, when an operator attempts to extract the pins by pulling the release handle, the operator is incapable of applying sufficient force to extract the lodged pins.

With the tandem operation, a second need is a device which is portable so that it can realistically be used for repeated applications on numerous trailers, is adapted for a one-person application, and which is self-contained thereby avoiding the need to modify the undercarriage of existing trailers.

One may also realize the third need to address the load bar operation. What is needed is a device to reach and engage the load bar and retention mechanism which in turn would make this load bar adjustment activity much safer and ergonomically correct.

One familiar with the trucking industry may also realize the fourth need to address having a heavy, mallet like to disengage. It may also be used in inclement weather to free iced up locks, brakes, loading pins and other trucking accessories. Also, some truckers check the tire inflation by hitting the tire and gauging the reaction from the blow by a heavy mallet or hammer.

Accordingly, a need has arisen for a portable apparatus adapted for one-person application, and which is further adapted for operating a fifth wheel pin; a tandem wheel adjustment system for a tractor trailer in order to extract or pull the tandem lock pin release handle; a safety reach mechanism for load bars; and a general purpose mallet. The development of the truck power puller device for semi-tractor and trailer applications called an Extreme Release™ fulfills this need.

### PRIOR ART

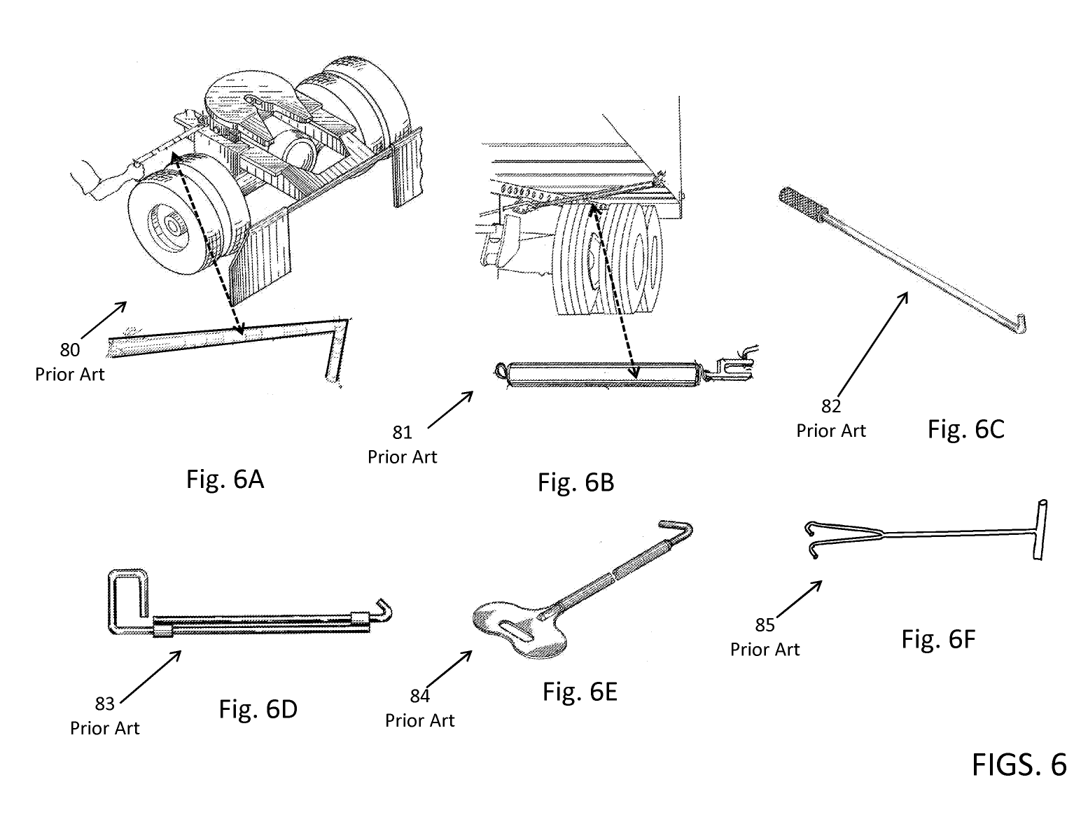

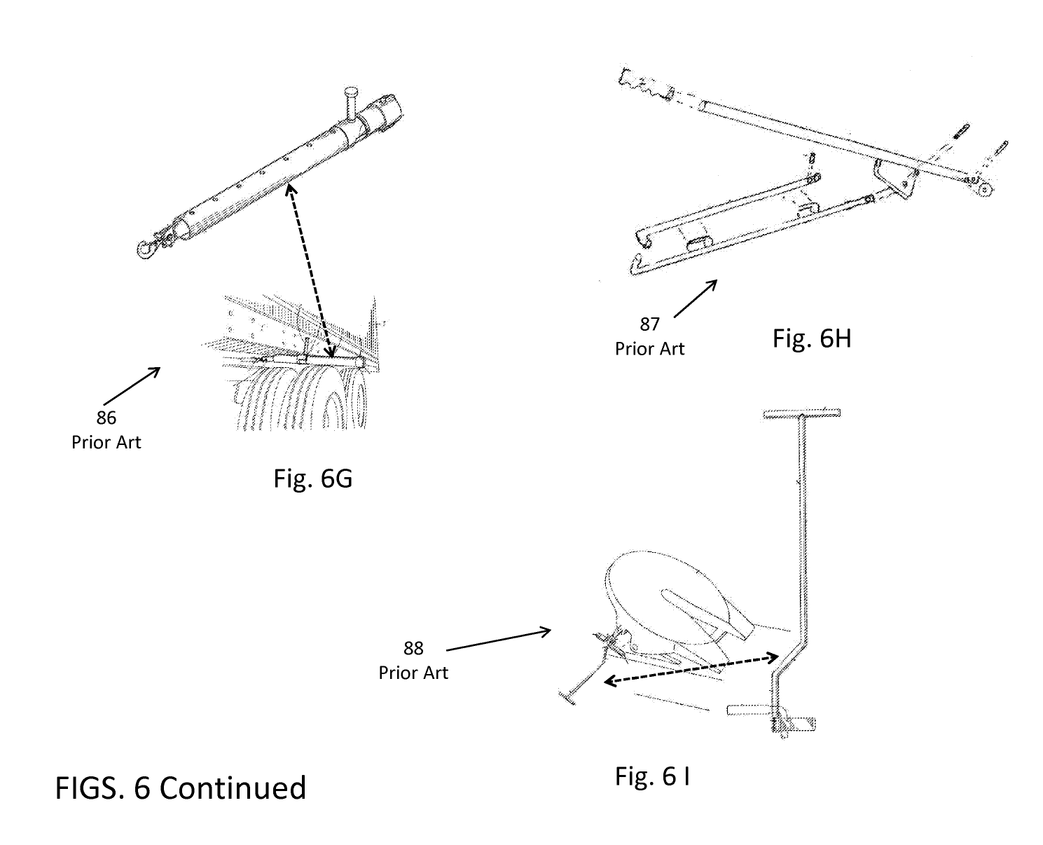

A search of the prior art did not disclose any patents that read directly on the claims of the instant invention; however, the following references were considered related. See FIG. 6 in the reference drawings. The following patents disclose various fifth wheel release and tandem axle pin puller devices:
A. U.S. Pat. No. 5,326,144 was issued in 1994 to Forcier and entitled a “Semitrailer sliding tandem pin puller”. It shows and describes a complex configuration, multiple parts, must attach to trailer, has no mallet, and has no load bar mechanism.
B. U.S. Pat. No. 5,344,201 was issued 1994 to Offin and is entitled a “Multi-function tool for truck operators”. It shows and describes no closed loop or mallet, has limited reach, and appears as a lightweight tube structure.
C. U.S. Pat. No. 5,626,063 was issued in 1997 to Kosbab and is entitled a “Tool for unlocking a fifth wheel locking handle”. It shows and describes a fifth wheel specific device and not a tandem or load bar device, and it has no described mallet (only grip handle).
D. U.S. Pat. No. 7,416,233 was issued in 2008 to Hinson and is entitled a “Tandem axle trailer pin extractor apparatus”. It shows and describes a tandem use only, with no mention of fifth wheel use, load bar use and has no described mallet. It is a very complex configuration of many components.
E. US Patent Application Publication 20030201651 by Lockhart is entitled a “Universal semitrailer fifth wheel and sliding tandem pin puller”. It shows and describes multiple, complex parts, appears lightweight, and describes no mallet or load bar use. Several U.S. Design patents showed ornamental sketches of tools without any functionality described.
F. U.S. Design 325,688 was issued in 1992 to Schreib and is entitled a “Combined Hook and Pusher Pole”. It shows no closed loop with hook. It appears short and of a lighter gauge material. There is no mallet nor a special configuration for load bar adjustments.
G. U.S. Design 330,494 was issued in 1992 to Eagle, Jr. and is entitled a “Fifth Wheel Pin Puller”. It appears as fifth wheel specific, with no tandem or load bar or mallet being described. The telescopic configuration may slide during use.
H. U.S. Design 475,258 was issued in 2003 to Wilson and is entitled a “Trucker's Utility Tool”. It shows no tandem or load bar use as obvious. There is no described mallet (only grip handle). Also there is no closed loop for tandem and fifth wheel use.
I. U.S. Design 566,495 was issued in 2008 to Hackmann and is entitled a “Multipurpose Truck Tool”. It shows no fifth wheel, no tandem, no load bar nor any described mallet (only grip handle). There is no closed loop shown. It appears to have very limited functionality.

One may note in the above references that light tools having a thin shaft and a hook on the end thereof have been used in the past to pull fifth wheel pins, but these tools are awkward to use and store, light weight, and are used only for a single purpose: removing fifth wheel pins. Also, they may slip off the handle and precipitate falls by the driver. A few complex extensions are commercially available that comprise a long shaft with a hook on the end to engage the lock release lever. The shaft is long enough to allow the operator to stand beside the semi-trailer and reach in to engage the lock release lever. However, only a “jerking” action on the lock release lever is possible by moving the hook past the lock release lever and then jerking it towards the operator. Such complex and rigid devices are too long to conveniently store in the tool boxes or compartments usually available on highway tractors, and so must be hung on the exterior of the vehicle where they are subject to loss, theft, and so forth.

### SUMMARY OF THE INVENTION

This invention is a Truck Power Puller device for Semi-tractor and trailer applications. Taught here are the ways to engage/dis-engage a fifth wheel device and a trailer/wheel device with this Truck Power Puller device for Semi-tractor and trailer applications.

The preferred embodiment of the Truck Power Puller device for Semi-tractor and trailer applications is a multipurpose truck power puller device for Semi-tractor and trailer applications, the device called an Extreme Release™, made of a durable material, a bend resistant configuration, and comprised of: (a) a heavy massed mallet and handle/tee section with features; (b) a shaft with sufficient mass and configuration to resist bending; (c) a means for connecting the mallet to the shaft; (d) a loop section with features and a heavy mass for engaging truck and trailer devices and features; (e) a hook section with features and mass for engaging truck and trailer devices and features; and (f) a means for connecting the loop and hook to the shaft wherein the puller device can be used as a portable apparatus adapted for a one-person application, and which is further adapted for operating a fifth wheel pin; a tandem wheel adjustment system for a tractor trailer; a safety reach mechanism for load bars; and a general purpose mallet.

The newly invented Truck Power Puller device for Semi-tractor and trailer applications may be manufactured at low volumes by very simple means and in high volume production by more complex and controlled systems.

### OBJECTS AND ADVANTAGES

There are several objects and advantages of the Truck Power Puller device for Semi-tractor and trailer applications. There are currently no known truck tool devise that are effective at providing the objects of this invention.

The following table show some example, but not limitations, of the objectives and benefits of the Truck Power Puller device for Semi-tractor and trailer applications. The objective is to provide a tool for truck operators that provides a favorable mix of the following benefits and factors.

TABLE A
Benefits:

| No. | OBJECTIVE/BENEFIT |
|---|---|
| 1 | Facilitates the removal of the fifth wheel pin; |
| 2 | Allows operators to loosen sticky hydraulic landing gear; |
| 3 | Improves the safety of the operator's working environment |
| | around tandem release area; |
| 4 | Is inexpensive to fabricate; |
| 5 | Is easy to use; |
| 6 | Provide a portable, tandem axle trailer pin extractor |
| | apparatus adapted for one-person application; |
| 7 | Provide a portable apparatus adapted for being removably |
| | securable to a tractor trailer in order to extract or pull |
| | the tandem lock pin release handle in a manner which is |
| | quick, easy, and efficient; |
| 8 | Provide an engagement means adapted for temporarily and |
| | removably securing the tension means to a tandem lock pin |
| | release handle; |
| 9 | Use on tandem axel release from outside the semi-trailer |
| | and stay free of the wheel zone; and |
| 10 | Use INSIDE the trailer to raise/lower the load bars safely. |

Finally, other advantages and additional features of the present a Truck Power Puller device for Semi-tractor and trailer applications will be more apparent from the accompanying drawings and from the full description of the device. For one skilled in the art of trucking connector devices and the like, it is readily understood that the features shown in the examples with this product are readily adapted to other types of truck and trailer connection systems and devices.

### DESCRIPTION OF THE DRAWINGS

### Figures

The accompanying drawings, which are incorporated in and constitute a part of this specification, illustrate an embodiment of the Truck Power Puller device for Semi-tractor and trailer applications that is preferred. The drawings together with the summary description given above and a detailed description given below serve to explain the principles of the Truck Power Puller device for Semi-tractor and trailer applications. It is understood, however, that the Truck Power Puller device for Semi-tractor and trailer applications is not limited to only the precise arrangements and instrumentalities shown.

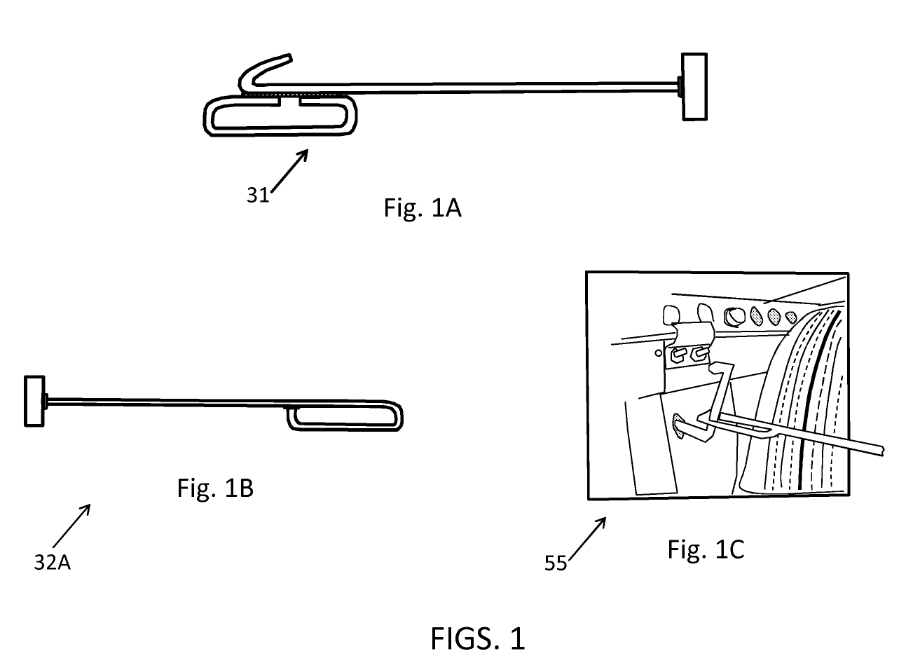

FIGS. 1 A through 1 C are sketches of the general Truck Power Puller device 30 for Semi-tractor and trailer applications.

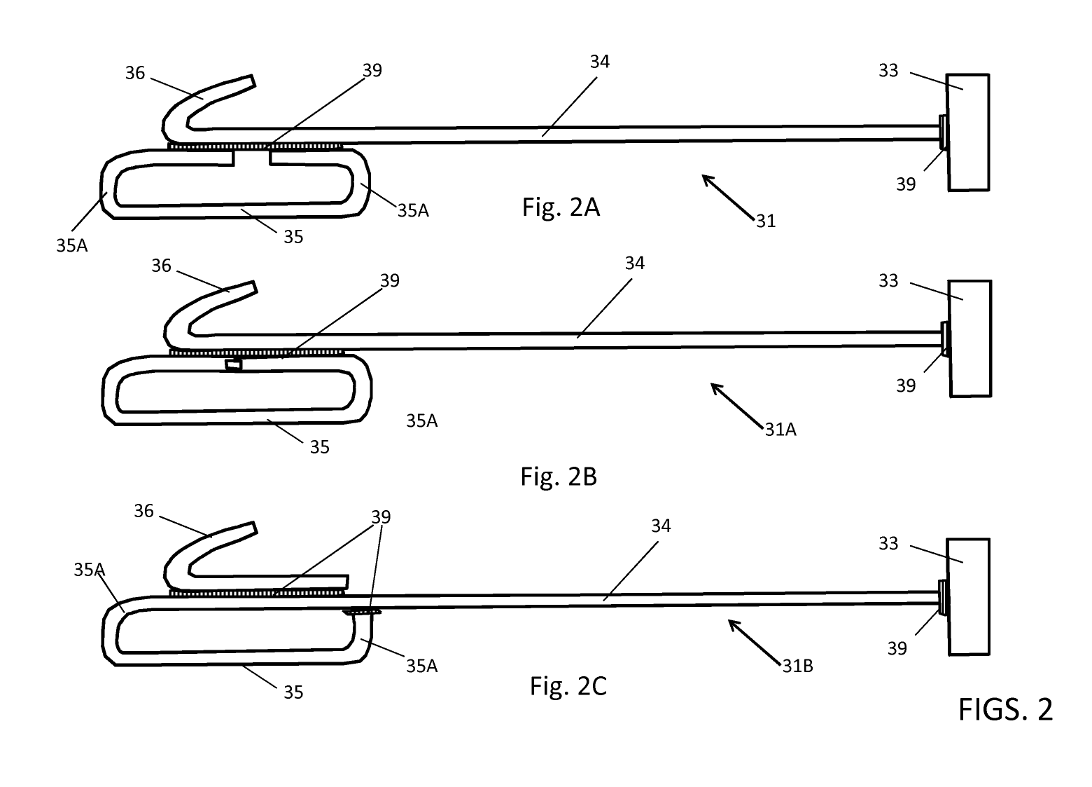

FIGS. 2 A through 2 C are sketches of a truck power puller device with components and features noted.

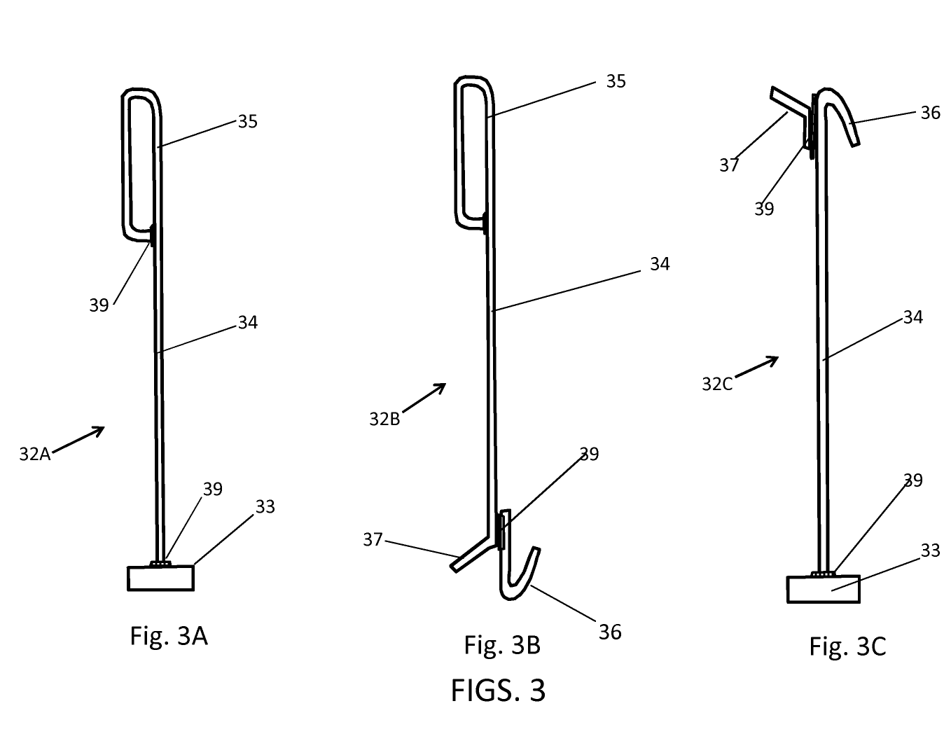

FIGS. 3 A through 3 C are of alternative prototype samples of the power puller device with the components and features shown from generally a top view.

FIGS. 4 A through 4 G are sketches of a sample in use with the trailer wheel pins from generally a side section.

FIGS. 5 A through 5 E are sketches of a sample in use with a fifth wheel pin release and load bars in semi-trailers.

FIGS. 6A through 6I are sketches of prior art devices.

### DESCRIPTION OF THE DRAWINGS

### Reference Numerals

The following list refers to the drawings:

TABLE B
Reference numbers:

| Ref # | Description |
|---|---|
| 30 | A general Semi-Tractor and Trailer Power Pull Device |
| 31 | Sketches of the preferred embodiment 31 Power Pull Device with |
| | open space in loop 35 |
| 31A | Sketches of the preferred embodiment 31A Power Pull Device |
| | with closed space in loop 35 |
| 31B | Sketches of the preferred embodiment 31B Power Pull Device |
| | with loop 35 integral to shaft 34 |
| 32A | Alternative embodiment Loop Only |
| 32B | Alternative embodiment Loop and Hook |
| 32C | Alternative embodiment Hook Only |
| 33 | Mallet or Handle/Tee with sufficient mass to be a hammer/ |
| | mallet for use as an urging device to impact and move the |
| | trailer elements |
| 34 | Shaft/Shank/Extension with sufficient size to withstand |
| | bending of the shaft when used as a hook device or deformation |
| | of the device when used as a hammer/impact device |
| 35 | Loop |
| 35A | Loop Radius |
| 36 | Hook |
| 37 | Short post opposite hook 36 |
| 38 | “Vee” at junction of loop 35 and hook 36 |
| 39 | Means for Connecting - Weld, Braze, Integral Mold |
| 40 | Trailer Bar Release |
| 50 | Trailer Tandem in middle position |
| 51 | Row of Apertures in Slider Pin Assembly |
| 52 | Trailer Pin Release Arm with Spring Mechanism in Back Center |
| 53 | Power Puller Pushed in on Bar Release |
| 54 | Slider Pin in Aperture |
| 55 | Pulling Bar Release Hard with device |
| 56 | Trailer Tandem slid all the way forward |
| 57 | Fifth Wheel System |
| 58 | Fifth Wheel System with Power Puller |
| 60 | Trailer |
| 61 | Wheels back |
| 61A | Wheels forward |
| 62 | Bar Release handle (springs loose the pin 63A) |
| 62A | Fifth Wheel Release Loop |
| 63 | Slider Pin Assembly Rail with Apertures 54 |
| 63A | Slider Pin |
| 65 | Fifth Wheel Mechanism |
| 70 | Load bar (telescoping with each end having a release 71) |
| 71 | Load bar spring release and detent mechanism |
| 72 | Essentially vertical side rails evenly spaced in the back of a |
| | semi-trailer |
| 73 | Notched track or receiving ratchet in the middle track of the |
| | side rails 72 |
| 75 | Operator/truck driver or dock assistant |
| 76 | Load - boxes, pallets or the like |
| 80 | Prior Art - U.S. Pat. No. 5,344,201 - Multi-function tool for |
| | truck operators |
| 81 | Prior Art - U.S. Pat. No. 5,326,144 - Semitrailer sliding tandem |
| | pin puller |
| 82 | Prior Art - US Design 475,258 - Trucker's Utility Tool |
| 83 | Prior Art - US Design 330,494 - Fifth Wheel Pin Puller |
| 84 | Prior Art - US Design 325,688 - Combined Hook and Pusher Pole |
| 85 | Prior Art - US Design 566,495 - Multipurpose Truck Tool |
| 86 | Prior Art - U.S. Pat. No. 7,416,233 - Tandem axle trailer pin |
| | extractor apparatus |
| 87 | Prior Art - US Publication 20030201651 - Universal semitrailer |
| | fifth wheel and sliding tandem pin puller |
| 88 | Prior Art - U.S. Pat. No. 5,626,063 - Tool for unlocking a fifth |
| | wheel locking handle |

### DETAILED DESCRIPTION OF PREFERRED EMBODIMENT

The present development is a Truck Power Puller device for Semi-tractor and trailer applications. Particularly this invention relates to a Power Puller device for Semi-tractor and trailer applications. In addition this device relates to tools employed by truck operators and, more particularly, to such tools used to release a fifth wheel pin of a tractor/trailer assembly or the wheel adjustments and tandem axle trailer pin extractor apparatus. The device is a tools and more particularly a decoupling tool for unlocking a fifth wheel assembly to allow decoupling of a trailer from a tractor and also a tool for shifting the locking pins in the undercarriage of a tandem axle trailer when it is desired to shift the position of the trailer body relative to the tandem axles. This may be as an original equipment option or an add-on system sold in the equipment aftermarket.

The advantages for the Truck Power Puller device 30 for Semi-tractor and trailer applications are listed above in the introduction. Succinctly the benefits are that the device:
1. Facilitates the removal of the fifth wheel pin;
2. Allows operators to loosen sticky hydraulic landing gear;
3. Improves the safety of the operator's working environment around tandem release area;
4. Is inexpensive to fabricate;
5. Is easy to use;
6. Provide a portable, tandem axle trailer pin extractor apparatus adapted for one-person application;
7. Provide a portable apparatus adapted for being removably securable to a tractor trailer in order to extract or pull the tandem lock pin release handle in a manner which is quick, easy, and efficient;
8. Provide an engagement means adapted for temporarily and removably securing the tension means to a tandem lock pin release handle;
9. Use on tandem axel release from outside the semi-trailer and stay free of the wheel zone; and
10. Use it INSIDE the trailer to raise and lower the load bars safely.

The preferred embodiment of the Truck Power Puller device 31 for Semi-tractor and trailer applications is a multipurpose truck power puller device for Semi-tractor and trailer applications, the device called an Extreme Release™, made of a durable material, a bend resistant configuration, and comprised of: (a) a heavy massed mallet 33 and handle/tee section with features; (b) a shaft 34 with sufficient mass and configuration to resist bending; (c) a means 39 for connecting the mallet to the shaft; (d) a loop section 35 with features and a heavy mass for engaging truck and trailer devices and features; (e) a hook section 36 with features and mass for engaging truck and trailer devices and features; and (f) a means 39 for connecting the loop 35 and hook 36 to the shaft 34 wherein the puller device 31 can be used as a portable apparatus adapted for a one-person application, and which is further adapted for operating a fifth wheel loop 62A; a tandem wheel adjustment system 52 for a tractor trailer; a safety reach mechanism for load bars 70; and a general purpose mallet 33.

There is shown in FIGS. 1-6 a complete description and operative embodiment of the Truck Power Puller device for Semi-tractor and trailer applications. In the drawings and illustrations, one notes well that the FIGS. 1-6 demonstrate both the general configuration and the use of this product. The various example uses are in the operation and use section, below.

The accompanying drawings, which are incorporated in and constitute a part of this specification, illustrate an embodiment of the Truck Power Puller device 30 for Semi-tractor and trailer applications that is preferred. The drawings together with the summary description given above and a detailed description given below serve to explain the principles of the Truck Power Puller device 30 for Semi-tractor and trailer applications. It is understood, however, that the Truck Power Puller device 30 for Semi-tractor and trailer applications is not limited to only the precise arrangements and instrumentalities shown. Other examples of truck pulling tools and uses are still understood by one skilled in the art of truck tooling devices to be within the scope and spirit shown here.

FIGS. 1 A through 1 C are sketches of the general Truck Power Puller device for Semi-tractor and trailer applications. FIG. 1 A shows the sketch of the preferred device 31 of the general power Puller device 30. FIG. 1 B is a sketch of an alternative embodiment 32A. FIG. 1 C is a sketch of the tandem in a pulled position 55 showing the use of the preferred embodiment of the device 31.

FIGS. 2 A through 2 C are sketches the preferred embodiment of a truck power puller device 31 with components and features noted. FIG. 2 A is a sketch of the preferred embodiment 31 Power Pull Device with open space in loop 35 FIG. 2 B a sketch of the preferred embodiment 31A Power Pull Device with closed space in loop 35. FIG. 2 C is a sketch of the preferred embodiment 31B Power Pull Device with loop 35 integral to shaft 34. All of these figures show the heavy mass handle/tee 33, the shaft/shank 34; the connection means 39 to rigidly connect the handle 33 to the shaft 34 (this handle 33 may have a removable means for attaching such as a threaded connection or a non-releasable and non-removable means for attaching such as welding, brazing or forming/molding/casting and an integral form of handle 33 and shaft/shank 34), a closed loop 35 and a hook 36. The Hook 36 may be integrally formed or molded to the device 30 or securely attached by an attaching means 39 (described above).

FIGS. 3 A through 3 D are sketches of alternative embodiments 32A, 32B and 32C. of the general power puller device 30 with the components and features shown from generally a top view. Alternative Prototype Loop Only 32A; Alternative Prototype Loop and Hook 32B; and Alternative Prototype Hook Only 32C. They all have similar parts and features including the heavy mass handle/tee 33, the shaft/shank 34; the connection means 39 to rigidly connect the handle 33 to the shaft 34 (this may be a removable means such as a threaded connection or a non-releasable means such as welding, brazing or forming/molding/casting and an integral form of handle 33 and shaft/shank 34), a closed loop 35 and a hook 36. The Hook 36 may be integrally formed or molded to the device 30 or securely attached by an attaching means 39.

For the various Truck Power Puller device 30 for Semi-tractor and trailer applications and alternatives, various materials and configurations are anticipated. There may be one of a plethora of design configurations such as a solid piece of material, tubular configurations [preferred is thick walled to be bend resistant], various solid and tubular sections such as circular, oval, square, rectangular, hexagonal and various similar polygonal sections. The ones selected must be a bend resistant, heavy duty mass. The materials may be comprised of a metal such as steel, alloy steel, brass or aluminum and may be coated with a powder coat, paint, or other surface finishes like anodizing, oxidizing, chrome plated or of other plating materials (zinc, etc.). The puller may also be made of a heavy duty, durable plastic or composite material. These lighter shafts may also require a joined, heavier handle section as necessary to have a heavy mass capable to be used as a release hammer if necessary.

FIGS. 4 A through 4 G are sketches of a prototype sample in use with the trailer wheel pins from generally a side section. FIGS. 5 A through 5 E are sketches of a sample in use with a fifth wheel pin release and use with load bars for semi-trailers. These are both described below in the Operations Section.

FIGS. 6A through 6I are sketches of prior art devices.

TABLE C
devices are identified as:

| DESCRIPTION | REFERNCE No. |
|---|---|
| U.S. Pat. No. 5,344,201 - Multi-function tool | 80 |
| for truck operators | |
| U.S. Pat. No. 5,326,144 - Semitrailer sliding | 81 |
| tandem pin puller | |
| US Design 475,258 - Trucker's Utility Tool | 82 |
| US Design 330,494 - Fifth Wheel Pin Puller | 83 |
| US Design 325,688 - Combined Hook and Pusher | 84 |
| Pole | |
| US Design 566,495 - Multipurpose Truck Tool | 85 |
| U.S. Pat. No. 7,416,233 - Tandem axle trailer | 86 |
| pin extractor apparatus | |
| US Publication 20030201651 - Universal | 87 |
| semitrailer fifth wheel | |
| and sliding tandem pin puller | |
| U.S. Pat. No. 5,626,063 - Tool for unlocking a | 88 |
| fifth wheel locking handle | |

The details mentioned here are exemplary and not limiting. Other specific components and manners specific to describing a Truck Power Puller device 30 for Semi-tractor and trailer may be added as a person having ordinary skill in the field of truck tools and coupling/decoupling mechanism devices and their uses well appreciates.

### Operation of the Preferred Embodiment

The Truck Power Puller device 30 for Semi-tractor and trailer applications has been described in the above embodiment. The manner of how the device operates is described below. One may note well that the description above and the operation described here must be taken together to fully illustrate the concept of the Truck Power Puller device for Semi-tractor and trailer applications. The preferred embodiment of the Truck Power Puller device for Semi-tractor and trailer applications is a multipurpose truck power puller device for Semi-tractor and trailer applications, the device called an Extreme Release™, made of a durable material, a bend resistant configuration, and comprised of: (a) a heavy massed mallet and handle/tee section with features; (b) a shaft with sufficient mass and configuration to resist bending; (c) a means for connecting the mallet to the shaft; (d) a loop section with features and a heavy mass for engaging truck and trailer devices and features; (e) a hook section with features and mass for engaging truck and trailer devices and features; and (f) a means for connecting the loop and hook to the shaft wherein the puller device can be used as a portable apparatus adapted for a one-person application, and which is further adapted for operating a fifth wheel pin; a tandem wheel adjustment system for a tractor trailer; a safety reach mechanism for load bars; and a general purpose mallet.

The Truck Power Puller device for Semi-tractor and trailer applications 30 operates as described in the introduction above. In a normal case, a truck operator's primary responsibility is to drive the tractor/trailer. Also, the truck operator is often responsible and called upon to perform duties such as disconnecting the tractor from the trailer and repositioning the wheels on the trailer. Truck operators traditionally do not have a full complement of tools available for performing their duties. The truck operator is often called on to disconnect or uncouple a fifth wheel pin employed to connect the trailer to the tractor. See FIG. 5 in the reference drawings. The fifth wheel pin is located between the tractor and the trailer above the rear tires of the tractor. The truck operator/driver is expected to bend down/over and reach between the tractor and the trailer past one set of rear tires to pull the fifth wheel pin. In addition, truck many/most semi-trailers are equipped with longitudinally-adjustable, tandem axle frame assemblies which slide in order to better distribute a load over the wheels or to support the rear of the trailer during loading. See FIG. 4 in the reference drawings. Generally, the tandem axle frame assemblies are secured to the sub-frame of the trailer by a series of heavy spring-loaded pins. The pins are spring-urged in such a manner whereby pins attempt to seat themselves within holes in a locking position in the sub-frame and tandem axle frame. A tandem lock pin release handle which extends outward of the frame is provided in order to facilitate extraction or withdrawal of the pins from the holes for tandem axle frame adjustment. When the release handle is pulled, a pulling force is exerted, thereby facilitating extraction of the pins so as to allow the tandem axle sub-frame to be repositioned and the pins allowed to seek appropriate holes to establish a new location of the trailer relative to the tandem axles. Often times the immensity of the masses involved with the trailer and the tandem axles and the forces there between causes the pins to be lodged in the locking position. Thus, because the operator is incapable of applying sufficient force to extract the jammed pins, he is required to return to his cab and slightly rock the semi-truck trailer back and forth in an attempt to dislodge the pins. Operator then re-attempts to pull the release handle in order to facilitate pin withdrawal. Most if not all truck semi-trailers are equipped with a sliding tandem frame which is slid to adjust the weight distribution of the cargo inside the semi-trailer. At the point on the semitrailer where the tandem wheels slide back and forth, there are normally four pins inside. These pins fit through openings in the flange-like frame on the side of the trailer box and extend to openings in the tandem frame. A handle is positioned underneath the pins and extending toward the outside of the trailer. The pins come in when the handle is pulled and the trailer frame then may slide on the tandem frame. In order for the tandem frame to slide, the holes must be lined up and the pins pulled out. If the pins are not lined up into the holes of the frame, the pins will stick and be very difficult to pull out. In this case, the semitrailer must be rocked back and forth until the pins line up. Usually the pins are pulled manually.

FIG. 4 A through 4 G are sketches of a sample in use with the trailer wheel pins from generally a side section. FIGS. 4 A through 4 G are sketches of a prototype sample 31 in use with the trailer wheel 61 pins 63 from generally a side section. FIG. 4 A shows a trailer tandem with the wheels in a middle position 50 which can be slid all the way to the back/Non-Prov. rear. FIG. 4 B shows a slider pin 63A in on the rail 63 in one of the apertures 54. FIG. 4 C shows the row of apertures/holes 54 for the slider pins 63A to slide the trailer wheels. Note also the release handle 62. FIG. 4 D provides a depiction of the trailer tandem wheels 61A slid all the way forward 56. FIG. 4 E shows the trailer pin release Arm 62 with the rail 63 and slider pin 63A a back, center position 52. FIG. 4 F shows the Truck Power Puller prototype device 31 for semi-tractor and trailer applications pushed in on the bar release handle 62. Note the loop 35 over the release 62. FIG. 4 G demonstrates the Power Puller 31 and the loop 35 pulling hard on the bar release Bar 62.

FIGS. 5 A and 5 B are sketches of a sample 31 in use with its hook 33 or loop 35 and engaging the release of a fifth wheel system 57 and its pin or loop 62A release. Note the closed loop 35, 35A prevents any slippage from the fifth wheel release 62A. FIGS. 5 C through 5 E are sketches of a sample 31 in use with a load bars 72 in semi-trailers. Here one sees the loop 35 and hook 36 of the device 31 create a “VEE” 38 at the junction. This “VEE” 38 is used to actuate the load bar spring release 71 at the ends of the telescoping load bar 70. This allows the load bar release 71 to move vertically along the vertical side rails 72. In the middle of the side rails 72 are notches 73 that permit the operator 75 to lower the bar 70 a portion at a time and ratchet the load bar safely into a desired height and position above the floor of the semi-trailer.

With this description it is to be understood that the Truck Power Puller device 30 for Semi-tractor and trailer applications is not to be limited to only the disclosed embodiment of product. The features of the Truck Power Puller device 30 for Semi-tractor and trailer applications are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

What is claimed is:

1. A multipurpose truck power puller device for Semi-tractor and trailer applications made of a durable material, a bend resistant configuration and comprised of:
(a) a heavy massed mallet and handle/tee section with features;
(b) a shaft with sufficient mass and configuration to resist bending;
(c) a means for connecting the mallet to the shaft;
(d) a loop section with features and a heavy mass for engaging truck and trailer devices and features;
(e) a hook section with features and mass for engaging truck and trailer devices and features; and
(f) a means for connecting the loop and hook to the shaft wherein the puller device can be used as a portable apparatus adapted for a one-person application, and which is further adapted for operating a fifth wheel pin; a tandem wheel adjustment system for a tractor trailer; a safety reach mechanism for load bars; and a general purpose mallet.

2. The device according to claim 1 wherein the durable material of the device is selected from the group consisting of a metal, steel, alloy steel, brass, aluminum, heavy duty plastic and heavy duty composite material.

3. The device according to claim 2 wherein the durable material may be surface finished is selected from the group consisting of powder coat, paint, anodizing, oxidizing and chroming.

4. The device according to claim 1 wherein the device configuration of material of the device is selected from the group consisting of solid round, solid hexagonal, solid square, circular tube, ovular tube, square tube, rectangular tube, hexagonal tube sections.

5. The device according to claim 1 wherein the mallet feature is an aperture to receive the shaft.

6. The device according to claim 1 wherein the means for connecting the mallet to the shaft is from a group consisting of threaded connection, welding, brazing, forming, integrally molding, and integrally casting.

7. The device according to claim 1 wherein the means for connecting the loop and hook to the shaft is from a group consisting of welding, brazing, forming, integrally molding, and integrally casting.

8. The device according to claim 1 further comprised of a closed loop section.

9. The device according to claim 1 further comprised of a open loop section.

10. A multipurpose truck power puller device for Semi-tractor and trailer applications made of a durable material, a bend resistant configuration and comprised of:
(a) a heavy massed mallet and handle/tee section;
(b) a shaft with sufficient mass and configuration to resist bending;
(c) a weld connecting the mallet to the shaft;
(d) a closed loop section of a heavy mass for engaging truck and trailer devices;
(e) a hook section with features and mass for engaging truck and trailer devices and features; and
(f) a weld connecting the loop and hook to the shaft wherein the puller device can be used as a portable apparatus adapted for a one-person application, and which is further adapted for operating a fifth wheel pin; a tandem wheel adjustment system for a tractor trailer; a safety reach mechanism for load bars; and a general purpose mallet.
